(19) United States
(12) Patent Application Publication
(10) Pub. No.: US 2003/0034952 A1
(43) Pub. Date: Feb. 20, 2003

(54) Elevation adjustable display module mounting arrangement for notebook computer

(76) Inventors: Shih-Hsuan Wang, Taipei (TW); Kun-Chen Lu, Taipei (TW); Ping-Chou Chen, Taipei (TW); Jain-Chen Yu, Taipei (TW); Chih-Cheng Tseng, Taipei (TW)

Correspondence Address: BACON & THOMAS, PLLC, 625 SLATERS LANE, FOURTH FLOOR, ALEXANDRIA, VA, 22314

(21) Appl. No.: 09/931,931

(22) Filed: Aug. 20, 2001

(51) Int. Cl. G09G 5/00

(52) U.S. Cl. 345/156; 361/683; 361/681

(57) ABSTRACT

An elevation adjustable display module mounting arrangement for notebook computer is constructed to include a front mainframe shell, a rear mainframe shell pivoted to the rear side of the front mainframe shell, a display module, and a coupling board coupled between the display module and the rear mainframe shell for enabling the display module to be turned relative to the rear mainframe shell and/or turned with the rear mainframe shell relative to the front mainframe shell.

### BACKGROUND OF THE INVENTION

The present invention relates to a notebook computer and, more specifically, to an elevation-adjustable display module mounting arrangement for notebook computer that enables the user to adjust the elevation and angle of the display module.

A regular notebook computer generally comprises a mainframe having a set of buttons, and a display module hinged to the rear side of the mainframe. When in use, the display module is turned outwards from the mainframe and set in the desired angle. When not in use, the display module is closed on the mainframe. However, because the elevation of the display module is not adjustable relative to the mainframe, the user cannot freely adjust the display module to the best-fit view position.

### SUMMARY OF THE INVENTION

The present invention has been accomplished under the circumstances in view. It is therefore the main object of the present invention to provide an elevation adjustable display module mounting arrangement for notebook computer, which enables the user to adjust the elevation as well as the angle of the display module. According to one embodiment of the present invention, the elevation adjustable display module mounting arrangement for notebook computer comprises a front mainframe shell, a rear mainframe shell pivoted to the rear side of the front mainframe shell, a display module, and a coupling board coupled between the display module and the rear mainframe shell for enabling the display module to be turned relative to the rear mainframe shell and/or turned with the rear mainframe shell relative to the front mainframe shell.

### BRIEF DESCRIPTION OF THE DRAWINGS

FIG. 1 is an exploded view of a notebook computer constructed according to the present invention.

FIG. 2 is an elevational assembly view of FIG. 1.

FIG. 3 is a side view of an alternate form of the present invention.

FIG. 4 is a side view of another alternate form of the present invention.

### DETAILED DESCRIPTION OF THE PREFERRED EMBODIMENT

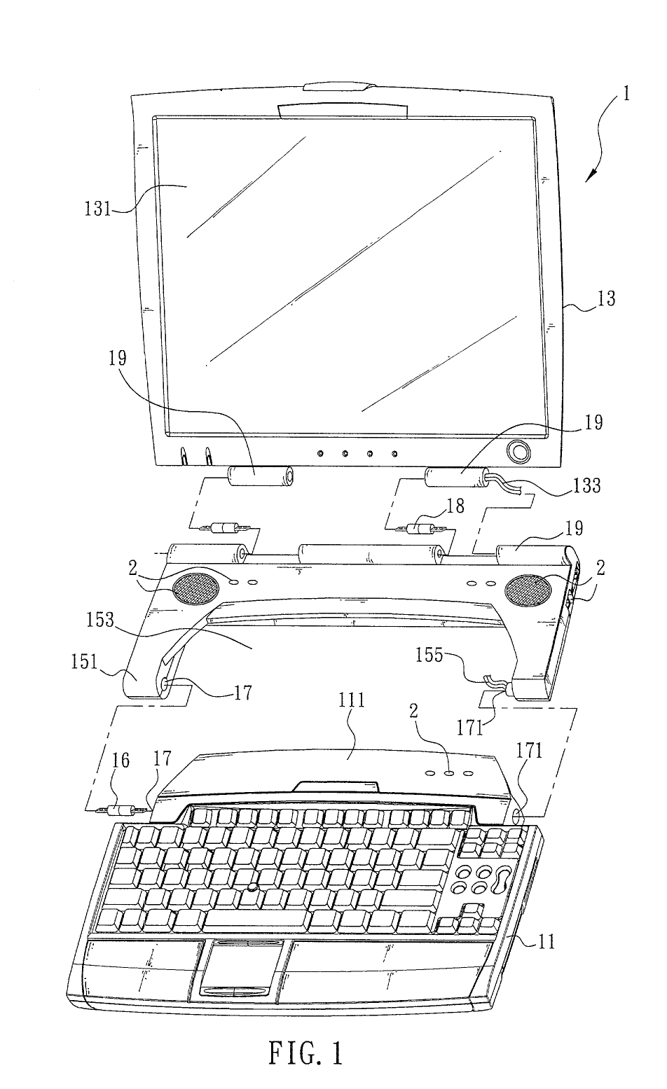

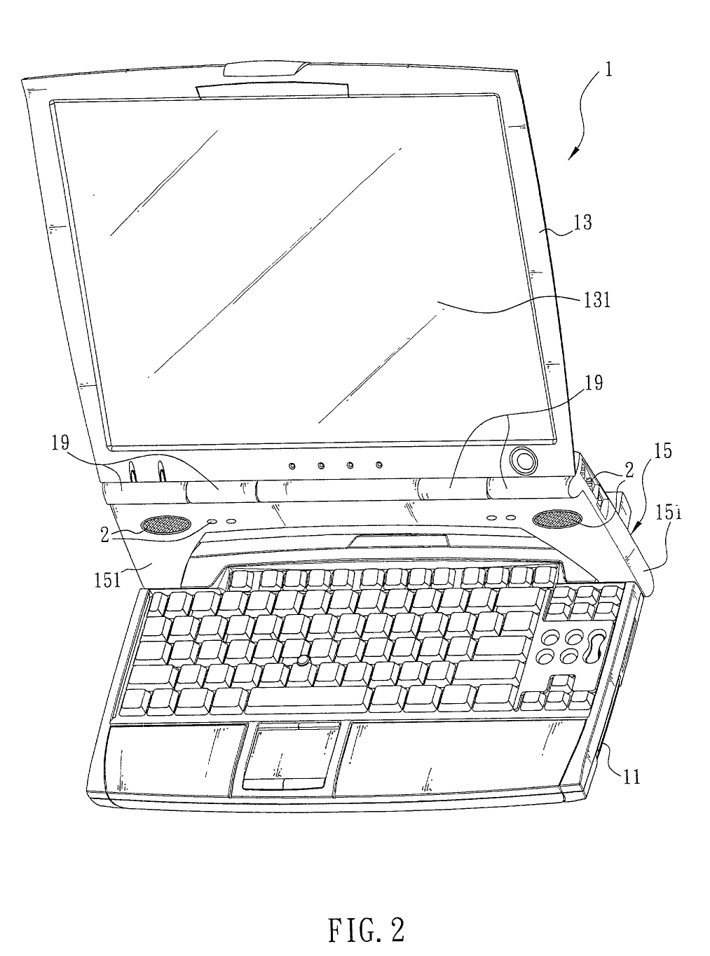

Referring to FIGS. 1 and 2, the notebook computer, referenced by 1, comprises a front mainframe shell 11, a rear mainframe shell 15, and a display module 13. The rear mainframe shell 15 is coupled between the front mainframe shell 11 and the display module 13. The front mainframe shell 11 holds the main electronic elements (main board, CPU, keyboard, memory, and etc.) for normal functioning of the notebook computer. The rear mainframe shell 15 holds the other subsidiary electronic elements 2 (I/O ports, speakers, battery, indicator lights, infrared transmitting and receiving circuit means, switches, and etc.). The display module 13 has a display panel 131 on its inner side. Pivot axles 16 are inserted into respective pivot holes 17 in one side, namely, the rear side of the front mainframe shell 11 and one side, namely, the front side of the rear mainframe shell 15 to coupled the front mainframe shell 11 and the rear mainframe shell 15 together, enabling the front mainframe shell 11 and the rear mainframe shell 15 to be turned relative to each other. Electric wires 155 are inserted through a respective transversely extended wire hole 171 in each of the front mainframe shell 11 and the rear mainframe shell 15 and connected between the electric circuit of the electronic elements in the front mainframe shell 11 and the electric circuit of the electronic elements 2 in the rear mainframe shell 15 for signal transmission between the electronic elements in the front mainframe shell 11 and the electronic elements 2 in the rear mainframe shell 15. Pivot axles 18 are fastened to barrels 19 at the other side, namely, the rear side of the rear mainframe shell 2 and one side, namely, the bottom side of the display module 13 for enabling the rear mainframe shell 15 and the display module 13 to be turned relative to each other. Electric wires 133 are inserted through the barrels 19 and connected between the electric circuit of the display panel 131 and the electric circuit of the electronic elements 2 of the rear mainframe shell 15, enabling the CPU of the electric circuit in the front mainframe shell 11 to control the operation of the display panel 131. When in use, the rear mainframe shell 15 is turned relative to the front mainframe shell 11 to adjust the elevation of the display module 13 and then set in the desired tilted position, and then the display module 13 is turned relative to the rear mainframe shell 15 to the desired angle (see FIG. 2).

Referring to FIGS. 1 and 2 again, the rear mainframe shell 15 has two coupling arms 151 bilaterally forwardly extended from the front side. The coupling arms 151 define a receiving space 153 therebetween. The front mainframe shell 11 has a coupling portion 111 backwardly extended from the rear side. The coupling portion 111 is inserted into the receiving space 153 and pivoted to the coupling arms 151 of the rear mainframe shell 15. Subsidiary electronic elements 2 (I/O ports, speakers, battery, indicator lights, infrared transmitting and receiving means, switches, and etc.) may be installed in the coupling portion 111.

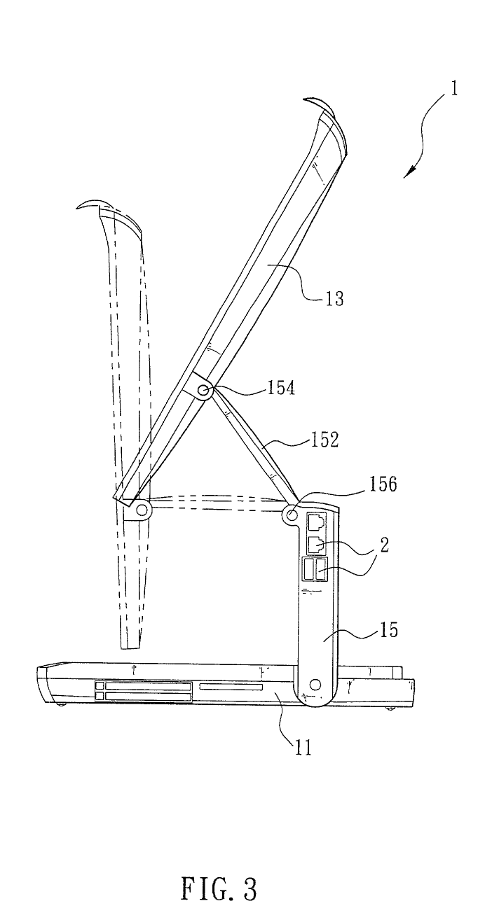

FIG. 3 shows an alternate form of the present invention. According to this alternate form, a coupling board 152 is coupled between the display module 13 and the rear mainframe shell 15. The coupling board 152 has one side, namely, the front side pivoted to the rear side of the rear mainframe shell 2 remote from the front mainframe shell 11 by pivot means 156, and the other side, namely, the rear side pivoted to the back side of the display module 13 by pivot means 154. Further, the rear mainframe shell 15 is pivoted to the front mainframe shell 11. When in use, the rear mainframe shell 2 is turned relative to the front mainframe shell 11 and set in vertical, and then the display module 13 is turned relative to the coupling board 152 and/or turned with the coupling board 152 relative to the rear mainframe shell 15 to the desired elevation and angle.

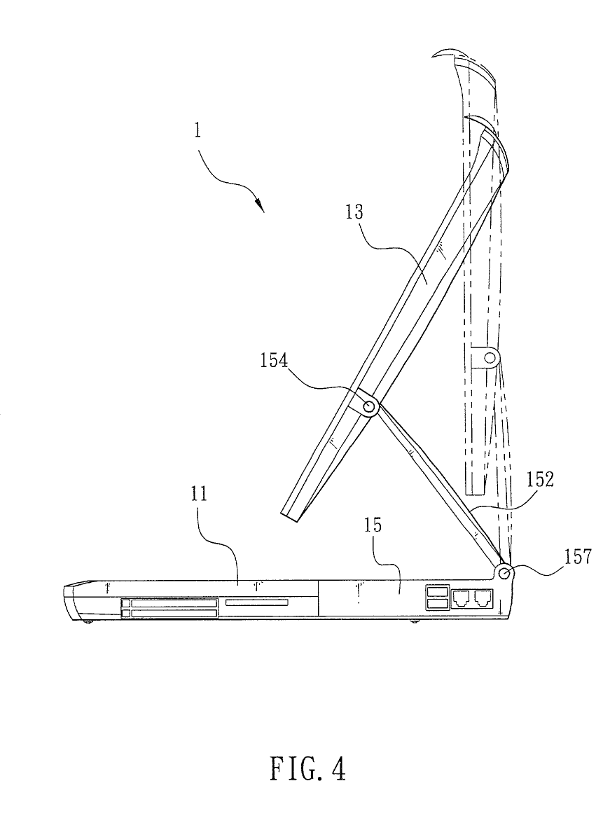

FIG. 4 shows another alternate form of the present invention. According to this alternate form, the notebook computer 1 comprises a front mainframe shell 11 and a rear mainframe shell 15 fixedly connected together, a display module 13, and a coupling board 152 coupled between the rear side of the rear mainframe shell 15 and the back side of the display module 13. The coupling board 152 has one side, namely, the front side pivoted to the rear side of the rear mainframe shell 2 remote from the front mainframe shell 11 by pivot means 157, and the other side, namely, the rear side pivoted to the back side of the display module 13 by pivot means 154. When in use, the coupling board 152 can be turned relative to the rear mainframe shell 15 to adjust the elevation of the display module 13, and the display module 13 can be turned relative to the coupling board 152 to the desired angle.

A prototype of elevation-adjustable display module mounting arrangement has been constructed with the features of the annexed drawings of FIGS. 1˜4. The elevation-adjustable display module mounting arrangement functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An elevation-adjustable display module mounting arrangement for notebook computer comprising:
a front mainframe shell holding a set of main electronic elements for notebook computer;
a display module holding a display panel; and
a rear mainframe shell holding a set of subsidiary electronic elements for notebook computer, said rear mainframe shell having a first side, a second side, first pivot means coupled between said first side and one side of said front mainframe shell for enabling said rear mainframe shell to be turned relative to said front mainframe shell, second pivot means coupled between said second side and one side of said display module for enabling said display module to be turned relative to said rear mainframe shell, wire holes respectively extended through said first pivot means and said second pivot means, and electric wires inserted through said wire holes and respectively connected between the display panel of said display module and the subsidiary electronic elements in said rear mainframe shell and between the subsidiary electronic elements in said rear mainframe shell and the main electronic elements in said front mainframe shell.

2. The elevation-adjustable display module mounting arrangement for notebook computer as claimed in claim 1 wherein said rear mainframe shell comprises two coupling arms bilaterally extended from the first side and respectively pivoted to said front mainframe shell by said first pivot means, and said front mainframe shell comprises a coupling portion inserted in between and pivoted to the coupling arms of said rear mainframe shell by said first pivot means.

3. The elevation-adjustable display module mounting arrangement for notebook computer as claimed in claim 1 further comprising a coupling board coupled between said rear mainframe shell and said display module, said coupling board having a first side pivoted to said second pivot means of said rear mainframe shell and a second side pivoted to a back side of said display module by pivot means.

4. The elevation-adjustable display module mounting arrangement for notebook computer as claimed in claim 1 wherein said subsidiary electronic elements include input/output port means.

5. The elevation-adjustable display module mounting arrangement for notebook computer as claimed in claim 1 wherein said subsidiary electronic elements include speaker means.

6. The elevation-adjustable display module mounting arrangement for notebook computer as claimed in claim 1 wherein said subsidiary electronic elements include battery means.

7. The elevation-adjustable display module mounting arrangement for notebook computer as claimed in claim 1 wherein said subsidiary electronic elements include indicator light means.

8. The elevation-adjustable display module mounting arrangement for notebook computer as claimed in claim 1 wherein said subsidiary electronic elements include infrared transmitting and receiving circuit means.

9. The elevation-adjustable display module mounting arrangement for notebook computer as claimed in claim 2 wherein said coupling portion of said mainframe shell has an electronic element installed therein.

10. Art elevation-adjustable display module mounting arrangement for notebook computer comprising:
a front mainframe shell holding a set of main electronic elements for notebook computer;
a rear mainframe shell holding a set of subsidiary electronic elements for notebook computer and fixedly connected to a rear side of said front mainframe shell;
a display module having a display panel for data display; and
a coupling board coupled between said display module and said rear mainframe shell, said coupling board having a first side pivoted to one side of said rear mainframe shell remote from said front mainframe shell by pivot means and a second side pivoted to a back side of said display module by pivot means.
